(19) United States
(12) Patent Application Publication
(10) Pub. No.: US 2023/0134734 A1
(43) Pub. Date: May 4, 2023

(54) CUSTOMIZING VIRTUAL STAIN

(71) Applicant: Carl Zeiss Microscopy GmbH, Jena (DE)

(72) Inventors: Alexander FREYTAG, Erfurt (DE); Christian KUNGEL, Penzberg (DE)

(73) Assignee: Carl Zeiss Microscopy GmbH, Jena (DE)

(21) Appl. No.: 17/915,717

(22) PCT Filed: Mar. 30, 2021
(86) PCT No.: PCT/EP2021/058273

§ 371 Date: Sep. 29, 2022

(30) Foreign Application Priority Data
Mar. 30, 2020 (DE) 10 2020 108 767.5

(51) Int. Cl. G06T 11/00; G06N 20/00

(52) U.S. Cl. CPC G06T 11/001; G06N 20/00; G06T 2210/41

(57) ABSTRACT

A method of virtual staining of a tissue sample includes obtaining imaging data depicting the tissue sample. The method also includes processing the imaging data in at least one machine-learning logic, the at least one machine-learning logic being configured to provide multiple output images all comprising a given virtual stain of the tissue sample, the multiple output images depicting the tissue sample comprising the given virtual stain at different colorings associated with different staining laboratory processes. The method further includes obtaining, from the at least one machine-learning logic, at least one output image of the multiple output images.

### FIELD OF THE INVENTION

Various examples generally relate to virtual staining of a tissue sample, i.e., providing one or more output images that depict the tissue sample including a virtual stain. Various examples specifically relate to customizing the virtual stain so as to provide output images depicting the tissue sample including the virtual stain at different colorings. Different colorings can be associated with different staining laboratory processes.

### BACKGROUND OF THE INVENTION

Histopathology examination is an important tool in the diagnosis of a disease. Histopathology refers to the optical examination of tissue samples. Diagnosis of cells in the tissue sample is facilitated.

Typically, histopathological examination starts with surgery, biopsy, or autopsy for obtaining the tissue to be examined. The tissue may be processed to remove water and to prevent decay. The processed tissue may then be embedded in a wax block. From the wax block, thin sections may be cut. Said thin sections may be referred to as tissue samples hereinafter.

The tissue samples may be analyzed by a histopathologist under a microscope. The tissue samples may be stained with a chemical stain using an appropriate staining laboratory process, to thereby facilitate the analysis of the tissue sample. In particular, chemical stains may reveal cellular components which are very difficult to observe in the unstained tissue sample. Moreover, chemical stains may provide contrast. The chemical stains may highlight one or more biomarkers or predefined structures of the tissue sample.

The most commonly used chemical stain in histopathology is a combination of haematoxylin and eosin (abbreviated H&E). Haematoxylin is used to stain nuclei blue, while eosin stains cytoplasm and the extracellular connective tissue matrix pink. There are hundreds of various other techniques which have been used to selectively stain cells. Recently, antibodies have been used to stain particular proteins, lipids and carbohydrates. Called immunohistochemistry, this technique has greatly increased the ability to specifically identify categories of cells under a microscope. Staining with an H&E stain may be considered as common gold standard for histopathologic diagnosis.

By coloring tissue samples with chemical stains, otherwise almost transparent and indistinguishable structures/tissue sections of the tissue samples become visible for the human eye. This allows pathologists and researchers to investigate the tissue sample under a microscope or with a digital bright-field equivalent image and assess the tissue morphology (structure) or to look for the presence or prevalence of specific cell types, structures or even microorganisms such as bacteria.

WO 2019/154987 A1 discloses a method providing a virtually stained image looking like a typical image of a tissue sample which has been stained with a conventional chemical stain using a machine-learning logic.

It has been found that the ability to correctly interpret images that depict tissue samples including a chemical stain can depend on the particular staining laboratory process used to generate the chemical stain. Thus, pathologists often require a specific staining laboratory process to be executed. This can limit the ability for second opinions based on existing images of a tissue sample including a chemical stain prepared by a specific staining laboratory process. For example, to be able to provide a second opinion, it can be required to re-stain a tissue sample, using a further staining laboratory process.

For example, the following workflow is conceivable in reference implementations, to obtain an accurate diagnosis. Pathologist A sends a tissue sample to laboratory A. Laboratory A prepares and stains the tissue sample and sends the stained probe back to the pathologist A. Laboratory A uses a respective laboratory staining process. Then, pathologist A can analyses the tissue sample including the chemical stain, e.g., using microscopy, etc. Sometimes, pathologist A can require a second opinion. Then, the stained probe can be sent to pathologist B. Pathologist B can examine the stained probe and provide his opinion back to pathologist A. In some scenarios, pathologist B may not be able to analyze the tissue sample having been stained using the laboratory process of laboratory A. Then, a further tissue sample — e.g., pertaining to another part or slice of the sample — may be transferred to a laboratory B, so as to also provide the chemical stain using another staining laboratory process. Then, pathologist B can examine the further tissue sample. Opinions can be consolidated.

Such an approach is time consuming and expensive. It is subject to availability of sufficient tissue samples: for example, if re-staining is required, then different tissue sample may be considered which also introduces a potential variation in the diagnosis.

### SUMMARY OF THE INVENTION

Therefore, a need exists for advanced techniques of providing images that depict tissue samples including a stain. A need exists for techniques that facilitate customizing a virtual stain.

This need is met by the features of the independent claims. The features of the dependent claims define embodiments.

A method of virtual staining of a tissue sample includes obtaining imaging data. The imaging data depicts the tissue sample. The method also includes processing the imaging data in at least one machine-learning logic. The at least one machine-learning logic is configured to provide multiple output images. The multiple output images all depict the tissue sample including a given virtual stain of the tissue sample. The multiple output images all depict the tissue sample including the given virtual stain. The different colorings are associated with different staining laboratory processes and/or configurations of an imaging modality used to acquire the imaging data. Further, the method includes obtaining at least one output image of the multiple output images from the at least one machine-learning logic.

Tissue samples may relate to thin sections of the wax block comprising an embedded processed sample as described hereinbefore. However, the term tissue sample may also refer to tissue having been processed differently or not having been processed at all. For example, tissue sample may refer to a part of tissue observed in vivo and/or tissue excised from a human, an animal or a plant, wherein the observed tissue sample has been further processed ex vivo, e.g., prepared using a frozen section method. A tissue sample may be any kind of a biological sample. The term tissue sample may also refer to a cell, which cell can be of procaryotic or eucaryotic origin, a plurality of procaryotic and/or eucaryotic cells such as an array of single cells, a plurality of adjacent cells such as a cell colony or a cell culture, a complex sample such as a biofilm or a microbiome that contains a mixture of different procaryotic and/or eucaryotic cell species and/or an organoid.

A computer-program product or a computer program or a computer-readable storage medium or a data signal includes program code. The program code can be loaded and executed by at least one processor. Upon executing the program code, the at least one processor performs a method of virtual staining of a tissue sample. The method includes obtaining imaging data. The imaging data depicts the tissue sample. The method also includes processing the imaging data in at least one machine-learning logic. The at least one machine-learning logic is configured to provide multiple output images. The multiple output images all depicting the tissue sample including a given virtual stain. The multiple output images all depict the tissue sample including the given virtual stain at different colorings. The different colorings are associated with different staining processes such as staining laboratory processes and/or configurations of an imaging modality used to acquire the imaging data. Further, the method includes obtaining at least one output image of the multiple output images from the at least one machine-learning logic.

A device includes a processor. The processor is configured to obtain imaging data. The imaging data depicts a tissue sample. The processor is further configured to process the imaging data in at least one machine-learning logic. The at least one machine-learning logic is configured to provide multiple output images. The multiple output images all depict the tissue sample. The tissue sample includes a given virtual stain. The multiple output images depict the tissue sample including the given virtual stain at different colorings. The different colorings are associated with different staining processes such as staining laboratory processes and/or configurations of an imaging modality used to acquire the imaging data. The processor is further configured to obtain, from the at least one machine-learning logic, at least one output image of the multiple output images.

A method of training at least one machine-learning logic for virtual staining of a tissue sample includes obtaining training imaging data. The training imaging data depicts one or more tissue samples. The method also includes obtaining multiple reference output images. The multiple reference output images depict the one or more tissue samples or one or more further tissue samples all including a given chemical stain. Different reference output images depict the one or more tissue samples or the one or more further tissue samples including the given chemical stain at different colorings provided by different staining processes such as staining laboratory processes and/or configurations of an imaging modality used to acquire the imaging data. The method also includes training the at least one machine-learning logic based on the training imaging data and the multiple reference output images.

The term chemical staining may also comprise modifying molecules of any one of the different types of tissue sample mentioned above. The modification may lead to fluorescence under a certain illumination (e.g., an illumination under ultra-violet (UV) light). For example, chemical staining may include modifying genetic material of the tissue sample. Chemically stained tissue samples may comprise transfected cells. Transfection may refer to a process of deliberately introducing naked or purified nucleic acids into eukaryotic cells. It may also refer to other methods and cell types. It may also refer to non-viral DNA transfer in bacteria and non-animal eukaryotic cells, including plant cells.

Modifying genetic material of the tissue sample may make the genetic material observable using a certain image modality. For example, the genetic material may be rendered fluorescent. In some examples, modifying genetic material of the tissue sample may cause the tissue sample to produce molecules being observable using a certain image modality. For example, modifying genetic material of the tissue sample may induce the production of fluorescent proteins by the tissue sample.

A computer-program product or a computer program or a computer-readable storage medium or a data signal includes program code. The program code can be loaded and executed by at least one processor. Upon executing the program code, the at least one processor performs a method of training at least one machine-learning logic for virtual staining of a tissue sample. The method includes obtaining training imaging data. The training imaging data depicts one or more tissue samples. The method also includes obtaining multiple reference output images. The multiple reference output images depict the one or more tissue samples or one or more further tissue samples all including a given chemical stain. Different reference output images depict the one or more tissue samples or the one or more further tissue samples including the given chemical stain at different colorings provided by different staining processes such as staining laboratory processes and/or configurations of an imaging modality used to acquire the imaging data. The method also includes training the at least one machine-learning logic based on the training imaging data and the multiple reference output images.

A device includes a processor. The processor is configured to obtain training imaging data. The training imaging data depicts one or more tissue samples. The processor is further configured to obtain multiple reference output images. The multiple reference output images depict the one or more tissue samples, or depict one or more further tissue samples, the one or more tissue samples or the one or more further tissue samples all comprising a given chemical stain. Different reference output images depict the one or more tissue samples of the one or more further tissue samples including the given chemical stain at different colorings. The different colorings are provided by different staining processes such as staining laboratory processes and/or configurations of an imaging modality used to acquire the imaging data. The processor is further configured to train the at least one machine-learning logic based on the training imaging data multiple reference output images.

A method of virtual staining of a tissue sample includes obtaining imaging data depicting the tissue sample including a chemical stain having a first coloring. The method also includes processing the imaging data in a machine-learning logic. The method further includes obtaining, from the machine-learning logic, an output image depicting the tissue sample including a virtual stain. The virtual stain is associated with the chemical stain. The virtual stain includes a second coloring that is different from the first coloring.

The virtual stain being associated with the chemical stain can pertain to the virtual stain and the chemical stain highlighting the same types of structures or biomarker(s).

A computer-program product or a computer program or a computer-readable storage medium or a data signal includes program code. The program code can be loaded and executed by at least one processor. Upon executing the program code, the at least one processor performs a method of virtual staining of a tissue sample. The method includes obtaining imaging data. The imaging data depicts the tissue sample including a chemical stain having a first coloring. The method also includes processing the imaging data in a machine-learning logic. The method further includes obtaining, from the machine-learning logic, an output image depicting the tissue sample including a virtual stain. The virtual stain is associated with the chemical stain. The virtual stain includes a second coloring that is different from the first coloring.

A device includes a processor. The processor is configured to obtain imaging data depicting the tissue sample including a chemical stain having a first coloring. The processor is also configured to the imaging data in a machine-learning logic. The processor is further configured to obtain, from the machine-learning logic, an output image depicting the tissue sample including a virtual stain. The virtual stain is associated with the chemical stain. The virtual stain includes a second coloring that is different from the first coloring.

It is to be understood that the features mentioned above and those yet to be explained below may be used not only in the respective combinations indicated, but also in other combinations or in isolation without departing from the scope of the invention.

### BRIEF DESCRIPTION OF THE DRAWINGS

FIG. 1 schematically illustrates a machine-learning logic according to various examples

FIG. 2 is a flowchart of a method according to various examples.

FIG. 3 is a flowchart of a method according to various examples.

FIG. 4 schematically illustrates a device according to various examples

### DETAILED DESCRIPTION OF THE INVENTION

Some examples of the present disclosure generally provide for a plurality of circuits or other electrical devices. All references to the circuits and other electrical devices and the functionality provided by each are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microcontrollers, machine-learning-specific hardware, e.g., a graphics processor unit (GPU) and/or a tensor processing unit (TPU), integrated circuits, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform operation(s) disclosed herein. In addition, any one or more of the electrical devices may be configured to execute a program code that is embodied in a non-transitory computer readable medium programmed to perform any number of the functions as disclosed.

In the following, embodiments of the invention will be described in detail with reference to the accompanying drawings. It is to be understood that the following description of embodiments is not to be taken in a limiting sense. The scope of the invention is not intended to be limited by the embodiments described hereinafter or by the drawings, which are taken to be illustrative only.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Various techniques described herein generally relate to machine learning. Machine learning, especially deep learning, provides a data-driven strategy to solve problems. Classic inference techniques are able to extract patterns from data based on hand-designed features, to solve problems; an example technique would be regression. However, such classic inference techniques heavily depend on the accurate choice for the hand-designed features, which choice depends on the designer’s ability. One solution to such a problem is to utilize machine learning to discover not only the mapping from features to output, but also the features themselves. This is referred to as training of a machine-learning logic.

Various techniques described herein generally relate to virtual staining of a tissue sample by utilizing at least one machine-learning logic (MLL). The at least one MLL can be implemented, e.g., by a support vector machine or a deep neural network which may include at least one encoder branch and at least one decoder branch.

The techniques described herein facilitate customizing the virtual stain. The customizing can pertain to providing output images having a desired coloring of the virtual stain. Thus, different appearances of one and the same virtual stain are possible.

The customizing can be in accordance with different staining processes such as staining laboratory processes. For example, different staining processes such as staining laboratory processes may exhibit variations for parameters of chemical treatments, e.g., temperatures, concentrations etc. Different staining processes such as staining laboratory processes may be subject to different laboratory noise. For instance, it has been found that different staining processes such as staining laboratory processes — although nominally providing the same chemical stain — can provide a tissue sample that includes the chemical stain having different colorings. On the other hand, medical personnel interpreting images of the tissue sample including the chemical stain often require a specific coloring in order to be able to reliably interpret the image.

The virtual stain can pertain to histopathology of tissue samples.

For example, it has been found that different pathologists often send a probe to different preferred chemical laboratories in order to obtain the tissue sample including the respective chemical stain having the required coloring. In such a scenario, it can be difficult to obtain a second opinion from a second pathologist, because the second pathologist may require the tissue sample to be re-stained at another chemical laboratory using another staining laboratory process (albeit using nominally the same chemical stain). This is costly and time-consuming and, sometimes, not even possible, e.g., if limited volume of the tissue sample is available.

Another example would pertain to virtual fluorescence staining. For example, in life-science applications, images of cells — e.g., arranged as live or fixated cells in a multi-well plate or another suitable container — are acquired using transmitted-light microscopy. Also, a reflected light microscope may be used, e.g., in an endoscope or as a surgical microscope. It is then possible to selectively stain certain cell organelles, e.g., nucleus, ribosomes, the endoplasmic reticulum, the golgi apparatus, chloroplasts, or the mitochondria. A fluorophore (or fluorochrome, similarly to a chromophore) is a fluorescent chemical compound that can re-emit light upon light excitation. Fluorophores can be used to provide a fluorescence chemical stain. By using different fluorophores, different chemical stains can be achieved. For example, a Hoechst stain would be a fluorescent dye that can be used to stain DNA. Other fluorophores include 5-aminolevulinic acid (5-ALA), fluorszine, and Indocyanine green (ICG) that can even be used in-vivo. Fluorescence can be selectively excited by using light in respective wavelengths; the fluorophores then emit light at another wavelength. Respective fluorescence microscopes use respective light sources. It has been observed that illumination using light to excite fluorescence can harm the sample; this is avoided when providing Fluorescence-like images through virtual staining. The virtual fluorescence staining mimics the fluorescence chemical staining, without exposing the tissue to respective excitation light. It has been observed that even if the same fluorophores are being used — i.e., nominally the same chemical stain is present —, there can be variation in the appearance induced by the laboratory process used to apply the fluorophores and/or the configuration of the optical microscope used to observe the tissue samples.

For instance, the used optics, the illumination, the excitation light source, etc. can introduce different appearances. It has been observed that albeit nominally the same chemical stain is used to highlight cell parts, interpretation of respective images can be difficult in view of the variability introduced by the multitude of available configurations of the optical microscope.

To mitigate such restrictions and drawbacks, according to various examples, imaging data of the tissue samples obtained. Then, the imaging data is processed at at least one machine-learning logic (MLL). The at least one MLL is configured to provide multiple output images. All multiple output images depict the tissue sample including one and the same virtual stain, however, at different colorings. This means that, e.g., the same biomarker or biomarkers or the same organelles of cells can be highlighted in the multiple output images, because they depict the same tissue including one and the same virtual stain that is selective to this biomarker or biomarkers or cell organelles. I.e., the same structures can be highlighted in the multiple images. The appearance of the biomarker or biomarkers or cell organelles can vary from output image to output image. The virtual stain can be associated with a single chemical stain, e.g., for histopathology: Hematoxylin and eosin (H&E), Ki67, human epidermal growth factor receptor 2 (HER2), estrogen receptor (ER), progesterone receptor (PR) - or other chemical stains. The virtual stain could be associated with the same fluorophore, e.g., a given Hoechst stain. It is then possible to obtain from the at least one MLL at least one output image of the multiple output images, the at least one output image depicting the tissue sample at the given virtual stain having a desired coloring. For instance, per iteration of execution of the MLL, a single output image may be obtained, depicting the tissue sample at the given virtual stain having a respective coloring associated with this iteration. Different iterations of the execution can then output different output images, all depicting the tissue same at the same virtual stain, but having different colorings; the MLL can be configured accordingly, to select a particular output image.

As a general rule, the coloring can define the relative contribution of different colors to the appearance of the virtual stain, e.g. a histogram across the color spectrum. The different colorings may be associated with different user preferences. The different colorings can show a dependency on the structures: thus, while similar structures are highlighted, the color of such labels may depend on the particular structure type and vary depending on the coloring. It is possible that the different colorings are associated with different staining processes such as staining laboratory processes: i.e., where different staining processes such as staining laboratory processes are used to generate the nominally same chemical stain, still there may be variance as to the color appearance; this variance can be reflected by the colorings of the respective virtual stain. Alternatively or additionally, different colorings could be associated with different configurations of the respective imaging modality. Then albeit nominally the same chemical stain is mimicked, the appearance can vary depending on the configuration.

Accordingly, while different ones of the output images all depict the tissue sample including the same virtual stain, the graphical appearance of the tissue sample may vary from output image to output image. Thereby, it is possible to facilitate accurate analysis of the information content of the output images, by tailoring the graphical appearance to the requirements of the reception and cognitive analysis of the output images by the pathologist. In particular, multiple pathologists may be able to provide a respective opinion and analysis, each pathologist using a customized virtual stain. Further, all pathologists can analyze the same tissue sample, instead of different tissue samples stained differently: For example, the same virtual stain may be analyzed for exactly the same tissue sample (in particular, the same slice of a tissue), having different customizations.

Imaging data of the tissue sample, as used herein, refers to any kind of data, in particular digital imaging data, representing the tissue sample or parts thereof. For example, depending on the imaging modality, the dimensionality of the imaging data of the tissue sample may vary. The imaging data may be two-dimensional (2-D), one-dimensional (1-D) or even three-dimensional (3-D). If more than one imaging modality is used for obtaining imaging data, a part of the imaging data may be two-dimensional and another of the imaging data may be one-dimensional or three-dimensional. For instance, microscopy imaging may provide imaging data that includes images having spatial resolution, i.e., including multiple pixels. Scanning through the tissue sample with a confocal microscope may provide imaging data comprising three-dimensional voxels. Spectroscopy of the tissue sample may result in imaging data providing spectral information of the whole tissue sample or large fractions thereof without spatial resolution. In another embodiment, spectroscopy of the tissue sample may result in imaging data providing spectral information for several positions of the tissue sample which results in imaging data comprising spatial resolution but being sparsely sampled.

Imaging modalities, as used herein, may include, e.g., imaging of the tissue sample in one or more specific spectral bands, in particular, spectral bands in the ultraviolet, visible and/or infrared range (multi-spectral microscopy). Image modalities may also comprise a Raman analysis of the tissue samples, in particular a stimulated Raman scattering (SRS) analysis of the tissue sample, a coherent anti-Stokes Raman scattering, CARS, analysis of the tissue sample, a surface enhanced Raman scattering, SERS, analysis of the tissue sample. Further, the image modalities may comprise a fluorescence analysis of the tissue sample, in particular, fluorescence lifetime imaging microscopy, FLIM, analysis of the tissue sample. The image modality may prescribe a phase sensitive acquisition of the digital imaging data. The image modality may also prescribe a polarization sensitive acquisition of the digital imaging data. Yet a further example would be transmitted-light microscopy, e.g., for observing cells. Imaging modalities may, as a general rule, image in-vivo or ex-vivo. An endoscope may be used to acquire images, e.g., a confocal microscope or using endoscopic optical coherence tomography (e.g., scanned or full-field). A confocal fluorescence scanner could be used. Endoscopic two-photon microscopy would be a further imaging modality. A surgical microscope may be used; the surgical microscope may, itself provide for multiple imaging modalities, e.g., microscopic images or fluorescence images, e.g., in specific spectral bands or combinations of two or more wavelengths, or even hyperspectral images.

As a general rule, it would be possible to use a single one or multiple MLLs in order to provide the multiple output images depicting the tissue sample including the virtual stain at different colorings of corresponding staining protocols. For instance, it would be possible to use a dedicated MLL per coloring. I.e., for each coloring, there could be a respective MLL. In such a scenario, it would be possible to train each one of the MLLs separately, based on respective training imaging data and ground truth output images depicting tissue samples including the respective chemical stain (corresponding to the desired virtual stain) using various colorings, e.g., as obtained from respective staining processes such as staining laboratory processes.

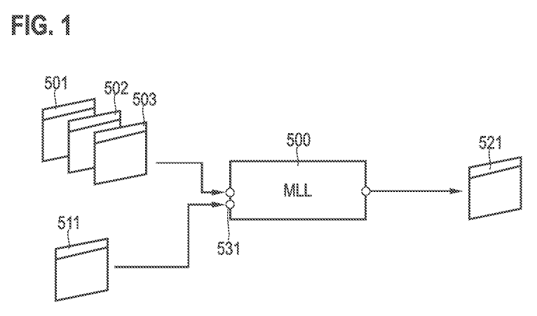

In other examples, it would be possible to use a single MLL that includes a conditional input. Then, by setting the conditional input, it is possible to select between the colorings associated with the different staining processes such as staining laboratory processes, to thereby obtain the respective output image from the single MLL. Such a scenario is illustrated in connection with FIG. 1.

FIG. 1 schematically illustrates aspects with respect to the MLL 500. The MLL 500 can be implemented by a deep neural network, e.g., having U-net architecture. See Ronneberger, Olaf, Philipp Fischer, and Thomas Brox. “U-net: Convolutional networks for biomedical image segmentation.” International Conference on Medical image computing and computer-assisted intervention. Springer, Cham, 2015.

More generally, the deep neural network can include multiple hidden layers. The deep neural network can include an input layer and an output layer. The hidden layers are arranged in between the input layer and the output layer. There can be a spatial contraction and a spatial expansion implemented by one or more encoder branches and one or more decoder branches, respectively (but this is optional: in other scenarios the spatial dimension may not be changed, possibly with the exclusion of edge cropping). For spatial contraction (expansion), the x-y-resolution of respective representations of the imaging data and the output images may be decreased (increased) from layer to layer along the one or more encoder branches (decoder branches); at the same time, feature channels can increase (decrease) along the one or more encoder branches (the one or more decoder branches). At the output layer or layers, the deep neural network can include decoder heads that can include an activation function, e.g., a linear or non-linear activation function, etc.

Each layer can provide one or more operations on the respective representatives of the input imaging data or the output images, such as: convolution, activation function (e.g., ReLU (rectified linear unit), Sigmoid, tanh, Maxout, ELU (Exponential Linear Unit), scaled Exponential Linear Unit (SELU), Softmax and so on), downsampling, upsampling, batch normalization, dropout, etc..

The MLL 500 processes imaging data: in FIG. 1, the MLL 500 processes multiple sets of imaging data 501-503, e.g., obtained using different imaging modalities and/or having different spatial resolution. It would be possible that the multiple sets of imaging data 501-503 depict the tissue sample not including or including a chemical stain. Different ones of the imaging data 501-503 may have different staining properties, i.e., different chemical stains or having/not having a chemical stain (i.e., some sets of the imaging data can depict the tissue sample having a chemical stain while others depict the tissue sample not having a chemical stain).

For example, the imaging data 501-503 could include input images having a spatial resolution. For example, a multispectral microscopy may be used. For example, one or more of the following imaging modalities may be used: hyperspectral microscopy imaging; fluorescence imaging; auto-fluorescence imaging; lightsheet imaging; Raman spectroscopy; etc.

The MLL 500 also processes data 511 provided to a conditional input 531 of the MLL 500. The data 511 could be labeled meta-data as it configures the operation of the MLL 500. The data 511 could be provided as a scalar or vector.

For instance, the data 511 could include an indicator that is indicative of a coloring that is selected from a predefined set of candidate colorings associated with predefined staining laboratory processes. In other words, there may be a finite set of candidate colorings and —e.g., based on a respective codebook — it is possible to select the appropriate coloring from the predefined set of candidate colorings, e.g. using a one-hot encoding or the like. This is illustrated in connection with TAB. 1 below.

TAB. 1

Data for conditional input of MLL, example

| Value of data 511 | Coloring | Explanation |
|---|---|---|
| 001 | Staining laboratory process A | H&E Stain |
| 010 | Staining laboratory process B | H&E Stain |
| 100 | Staining laboratory process C | H&E Stain |
| 011 | Staining laboratory process D | H&E Stain |
| 101 | Staining laboratory process E | H&E Stain |
| 111 | Staining laboratory process F | H&E Stain |

In another example, the conditional input can select between the colorings in accordance with a target color map that is provided to the conditional input.

The target color map parameterizes the coloring associated with a respective staining laboratory process. There can be different options for implementing the target color map. For instance, the target color map could be a red-green-blue vector (here, for training, a respective training input in grayscale and an associated red-green-blue vector can be used, along with an associated ground truth reference output image obtained from the respective laboratory staining process associated with the red-green-blue vector). Other color spaces such as CYMK or HSV are possible. This corresponds to a colormapping. For instance, the target color map could specify a color histogram or, more generally, a relative contribution of the various colors to the virtual stain of the tissue sample in the respective output image, e.g., dependent on biomarkers highlighted by the virtual stain. The target color map could — as a general rule —specify which structure types of the tissue sample are highlighted using which color. Thus, by varying the values of the target color map, the appearance/coloring of the virtual stain can be altered. The target color map thus parameterizes the coloring.

There are, as a general rule, various options available for implementing the MLL to be able to process the data 511 at the conditional input 531. For example, it would be possible that different decoder heads of the deep neural network are selected, depending on the data 511 at the conditional input 531 (i.e., by setting the conditional input), to thereby obtain different ones of the multiple output images. The different decoder heads can be selected depending on the data 511 at the conditional input 531. Another example implementation can rely on a conditional neural network, e.g., as described by Phillip Isola, Jun-Yan Zhu, Tinghui Zhou, and Alexei A. Efros. “Image-to-Image Translation with Conditional Adversarial Networks”, in CVPR 2017. https://arxiv.org/pdf/1611.07004// Pix2Pix. Yet another example implementation can rely on an invertible Neural Networks with conditional information as described by Ardizzone, Lynton, et al. “Guided image generation with conditional invertible neural networks.” arXiv preprint arXiv:1907.02392 (2019).

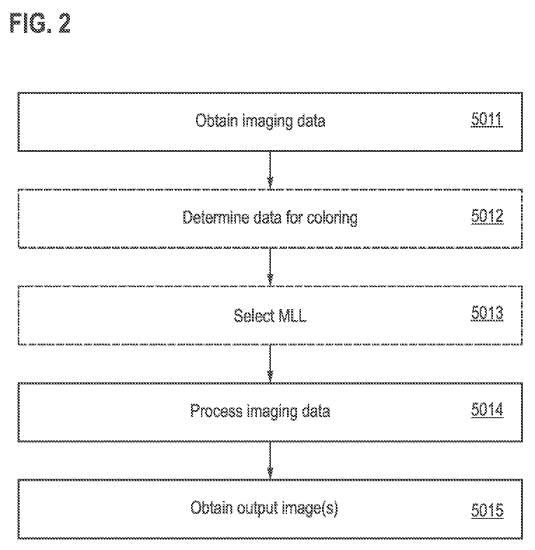

FIG. 2 is a flowchart of a method according to various examples. For example, the method of FIG. 2 may be executed by at least one processor upon loading program code from a nonvolatile memory. The method facilitates virtual staining of a tissue sample. I.e., one or more output images are provided that depict a tissue sample having a given virtual stain. For example, the given virtual stain could be associated with a respective chemical stain that is achievable by a respective staining laboratory process. Example virtual stains thus include, e.g., virtual H&E, virtual Ki67, virtual HER2, virtual ER, or virtual PR.

Initially, at box 5011, imaging data 501-503 depicting a tissue sample is obtained. The imaging data 501-503 may be obtained via a communication interface, e.g., from a remote node. For instance, multiple sets of imaging data 501-503 may be obtained. Different sets may be acquired using different imaging modalities. It would be possible that the imaging data 501-503 include spatially-resolved images. Different imaging data may depict the tissue sample having different chemical stains. For example, the imaging data 501-503 can depict the tissue sample including or not including a given chemical stain that is associated with the virtual stain. For example, the imaging data 501-503 may — at least partially — depict the tissue sample including an H&E stain. The chemical stain of the tissue sample depicted by the imaging data 501-503 can be different to the given virtual stain; this would correspond to virtual re-staining. The chemical stain of the tissue sample depicted by the imaging data 501-503 can also be the same as the given virtual stain; this would correspond to virtual re-coloring; thereby, based on a chemical stain provided by a first laboratory process, the corresponding virtual stain can be generated that corresponds to a second laboratory process. Thus, e.g., one or more input images can depict the tissue sample including a first coloring; and the one or more output images can depict the tissue sample including at least one second coloring that is different from the first coloring. This helps to harmonize across different laboratory processes.

At optional box 5012, it is possible to determine data 511 that defines or selects the coloring. For example, the data 511 can be for a conditional input 531 of an MLL, or may be used to select amongst multiple MLLs. For example, it would be possible to determine an indicator value to thereby select the appropriate coloring from a set of predefined colorings, e.g., as illustrated in TAB. 1. It would also be possible to determine a target color map that parameterizes the coloring. For instance, the target color map may specify which type of structures or geometries of structures are highlighted using which color.

As a general rule, there are various options available for determining the data 511 including the target color map at box 5012.

For example, it would be possible that the target color map is determined based on one or more predefined target color maps that parameterize the colorings associated with respective one or more further staining laboratory processes. This means, in other words, that the target color map determined at box 5012 can be derived from one or more predefined target color maps. For instance, a given predefined target color map may be altered by incrementally changing its values, to thereby obtain the target color map. In a further example, an interpolation between two or more predefined target color maps can be used to determine the target color map. Thereby, a transition from the one or more further staining laboratory processes, e.g., between two of the further staining laboratory processes, can be implemented. A trade-off between multiple further laboratory staining processes can be implemented. For example, it would be possible to implement a time evolution that blends from the coloring of a first further staining laboratory process to the coloring of a second further staining laboratory process. I.e., over the course of time a respective shift from the coloring associated with the first further staining laboratory process to the coloring associated with the second further staining laboratory process can be implemented. In a concrete example, it would be possible that in week 1, the pathologist is presented with an output image that depicts the tissue sample including a coloring that is associated with a given further staining laboratory process (process A) preferred by the respective pathologist. Then, over the course of time, the coloring can be changed, e.g., in week 2, the coloring can be determined to be 90% in accordance with the process A and 10% in accordance with another further staining laboratory process (process B). The blending can go on towards process B, e.g., 80%-20% in week 3, and so forth. Such techniques can be helpful to slowly, but steadily arrive at a single consistent staining that can be shared among multiple staining labs or staining laboratory processes. In conclusion and speaking generally, it is thus, possible, that the determining of the data 511 including the target color map depends on a time evolution associated with a transition from the one or more predefined target color maps to the respective target color map. The target color map can thus include two or more target color maps, wherein the target color maps is determined based on a weighted combination of at least two of the two or more predefined target color maps.

At optional box 5013, it is then possible to select, e.g., based on the data of box 5012, the appropriate machine-learning logic. For example, different neural networks may be available for different target colour maps.

In other examples, one and the same machine-learning logic may be configured to receive the data 511 at a conditional input 531. This has been explained above in connection with FIG. 1. Then, box 5013 is not required.

Next, at box 5014, the imaging data of box 5011 is processed. This is done using, e.g., the selected machine-learning logic of box 5013; or using a single machine-learning logic that, in parallel, receives the data 511 at its conditional input 531.

Then, box 5015, an output image is received that depicts the tissue sample having the given virtual stain coloring associated with a respective staining laboratory process of an associated chemical stain. For example, a single output image may be received that depicts the tissue sample including the virtual stain having the coloring as defined by the data 511 of box 5012. It would also be possible to process the imaging data of box 5011 in multiple iterations for multiple data 511, thereby obtaining multiple output images that depict the tissue sample including the virtual stain having respective colorings.

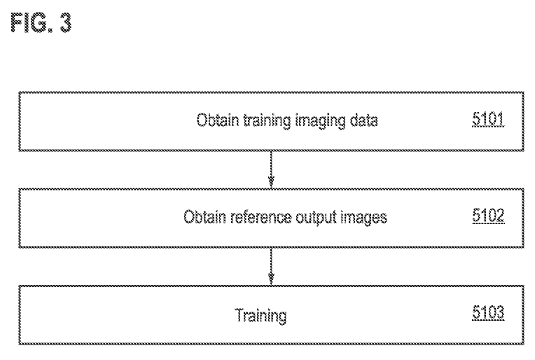

The method of FIG. 2 pertains to inference using a trained machine-learning logic 500. Next, details with respect to training of the machine-learning logic 500 are discussed in connection with FIG. 3.

FIG. 3 is a flowchart of a method according to various examples. For example, the method of FIG. 3 may be executed by at least one processor upon loading program code from a nonvolatile memory.

The method of FIG. 3 can be used to train a machine-learning logic that is configured to provide virtual staining of a tissue sample in one or more output images provided by the machine-learning logic.

By means of the method of FIG. 3, a single machine-learning logic may be trained or multiple machine-learning logics may be trained. This correlates with whether a single machine-learning logic includes a conditional input 531 or whether multiple machine-learning logics are used to provide output images that depict a tissue sample including a virtual stain having multiple colourings, as explained above in connection with FIG. 2: box 5013.

At box 5101, training imaging data is obtained. The training imaging data depicts one or more tissue samples. The tissue samples may or may not include a chemical stain. For example, where the training imaging data depicts the one or more tissue samples including a chemical stain, a scenario of re-staining or re-coloring can be implemented. The training imaging data may be acquired using one or more imaging modalities. The training imaging data may be obtained from a database.

The training imaging data can correspond to the imaging data obtained at box 5011, i.e., include a similar chemical stain or no stain, have corresponding dimensionality, having been acquired with the same corresponding imaging modalities, etc.

Next, at box 5102, multiple reference output images are obtained. The multiple reference output images all depict the one or more tissue samples including a given chemical stain; i.e., the one or more tissue samples are all highlighting the same biomarkers/have the same chemical stain across the multiple reference output images.

Thus, the reference output images serve as ground truth further training of the machine-learning logic or machine-learning logics.

In some examples, it is possible that the training imaging data is registered to the multiple reference output images; more specifically, training images included in the training imaging data can be registered to the multiple reference output images. This means that corresponding sections included in the training images and the reference output images are linked to each other. Thereby, a value of a loss function considered in the training can be determined by determining a difference between the training imaging data and the training output images generated by the one or more machine-learning logics based on the training imaging data, and the reference output images, respectively. For example, a difference in contrast may be considered. It would be possible to consider a structural difference or a different in texture. More generally, a difference in the appearance can be considered. However, it is not required in all scenarios that the training imaging data is registered to the multiple reference output images. For example, in other scenarios, non-registered training imaging data and reference output images may be used. Here, e.g., it may be possible to use a cyclic Generative Adversarial Networks (GAN).

The term cycle GAN as used herein may comprise any generative adversarial network may refer to any generative adversarial network which makes use of some sort of cycle consistency during training. In particular the term cycle generative adversarial network may comprise cycleGAN, DiscoGAN, StarGAN, Dualgan, CoGAN, UNIT.

Examples for such architectures are described in: CycleGAN: see, e.g., Zhu, J. Y., Park, T., Isola, P., & Efros, A. A. (2017). Unpaired image-to-image translation using cycle-consistent adversarial networks. In Proceedings of the IEEE international conference on computer vision (CVPR). DiscoGAN: see, e.g., Kim, T., Cha, M., Kim, H., Lee, J. K., & Kim, J. (2017, August). Learning to discover cross-domain relations with generative adversarial networks. In Proceedings of the 34th International Conference on Machine Learning-Volume 70 (pp. 1857-1865). JMLR. org. StarGAN: See, e.g., Choi, Y., Choi, M., Kim, M., Ha, J. W., Kim, S., & Choo, J. (2018). Stargan: Unified generative adversarial networks for multi-domain image-to-image translation. In Proceedings of the IEEE conference on computer vision and pattern recognition (CVPR). DualGAN: see, e.g., Yi, Z., Zhang, H., Tan, P., & Gong, M. (2017). Dualgan: Unsupervised dual learning for image-to-image translation. In Proceedings of the IEEE international conference on computer vision (ICCV). CoGAN. See, e.g., M.-Y. Liu and O. Tuzel. Coupled generative adversarial networks. Advances in Neural Information Processing Systems (NIPS), 2016. UNIT: see, e.g., Liu, Ming-Yu, Thomas Breuel, and Jan Kautz. “Unsupervised image-to-image translation networks.” In Advances in neural information processing systems (NIPS), 2017.

Then, at box 5103, the training of the one or more MLLs is executed. This is based on the training imaging data obtained at box 5101, as well as based on the reference output images obtained at box 5102. For example, where multiple machine-learning logics are trained, this can be done separately for each one of the multiple machine-learning logics based on a loss function that is determined based on a respective subset of the reference output images depicting the one or more tissue samples having the chemical stain at the respective coloring.

The training can use a cyclic GAN approach: here, the MLL can implement the generator logic in each one of the forward cycle and the backward cycle; and another neural network can be used as discriminator.

The training can consider the spatial registration, as explained above, to determine a loss function based on differences in contrast amongst the various spatial region. A pixel-wise difference would be possible. In some implementations a structured similarity index (https://www.ncbi.nlm.nih.gov/pubmed/28924574) may be used as a loss function. Multiple loss function may be combined, e.g., in a weighted manner.

Backpropagation to adjust the weights across the various layers of the neural network can be used.

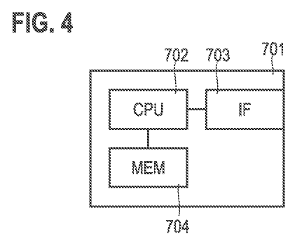

FIG. 4 schematically illustrates a device 701 according to various examples. The device 701 includes a processor 702 and a memory 704. The processor 702 can load program code from the memory 704. The processor 702 can execute the program code. Upon executing the program code, the processor 702 can perform one or more of the following logic operations as described throughout this disclosure: obtaining imaging data, e.g., via an interface 703 of the device 701 or by loading the imaging data from the memory 704; virtual staining of the tissue sample depicted by the imaging data; executing at least one machine-learning logic to process the imaging data (inference) e.g. in multiple iterations; obtain at least one output image, from the machine-learning logic/when executing the machine-learning logic, e.g., to output the at least one output image via the interface 703; setting parameters or hyperparameters of the machine-learning logic when training the machine-learning logic; training the machine-learning logic; etc. For example, the method of FIG. 2 the method of FIG. 3 could be executed by the processor 702 upon loading the program code.

Although the invention has been shown and described with respect to certain preferred embodiments, equivalents and modifications will occur to others skilled in the art upon the reading and understanding of the specification. The present invention includes all such equivalents and modifications and is limited only by the scope of the appended claims.

For illustration, various examples have been described in connection with a single MLL that is configured to output multiple output images, e.g., depending on a conditional input of the MLL. Similar techniques may also be applied to scenarios in which multiple MLLs are used, each one being configured to output a single output image. Then, instead of using a conditional input, an appropriate selection between the multiple MLLs can be implemented. Still further, scenarios are conceivable in which the (single) MLL is configured to provide only a single output image, e.g., in a scenario pertaining to re-coloring as described below.

For further illustration, scenarios have been described in which re-coloring is possible. As a general rule, it would be possible to use an MLL that is configured to provide an output image depicting the tissue sample including a virtual stain; here, the input image provided to the MLL can depict the tissue sample including a chemical stain that is associated with the virtual stain (i.e., both are H&E-type or Ki67 stains, etc.). The input image and the output image depict the tissue sample including the respective stain at different colourings.

For still further illustration, above, various scenarios have been disclosed in which a customized coloring of a virtual stain of a tissue sample is provided in an output image, the customized coloring being associated with a specific staining process for the nominally same underlying chemical stain. Specifically, the staining laboratory process can be used to generate a chemical stain for histopathology. In further examples, it would be possible to provide images that have customized colorings of a virtual stain, the customized colorings being associated with different configurations of the same imaging modality. For example, it has been observed that depending on the particular configuration of the imaging modality, even the nominally same chemical stain can have different graphical appearances. By providing the customized coloring, it is possible to mimic such different graphical appearances that depending on the configuration of the imaging modality. To give an example, it has been observed that for fluorescence imaging of cell samples, the configuration of a respective transmitted-light microscope can vary the appearance of the highlighted cell organelles. For instance, the brightness level of a fluorescence light source used to excite fluorophores can change the appearance of the fluorophores in the respective images.

1. A method of virtual staining of a tissue sample, the method comprising:
obtaining imaging data depicting the tissue sample,
processing the imaging data in at least one machine-learning logic, the at least one machine-learning logic being configured to provide multiple output images all depicting the tissue sample comprising a given virtual stain, the multiple output images depicting the tissue sample comprising the given virtual stain at different colorings associated with different staining laboratory processes, and
obtaining, from the at least one machine-learning logic, at least one output image of the multiple output images.

2. The method of claim 1,
wherein the at least one machine-learning logic comprises a single machine-learning logic, the single machine-learning logic comprising a conditional input,
wherein setting the conditional input selects between the colorings associated with the different staining laboratory processes, to thereby obtain the respective output image of the multiple output images from the single machine-learning logic.

3. The method of claim 2,
wherein the conditional input selects between the colorings from a predefined set of candidate colorings associated with predefined staining laboratory processes.

4. The method of claim 2,
wherein the conditional input selects between the colorings in accordance with a target color map provided to the conditional input, the target color map parametrizing the coloring associated with a respective staining laboratory process.

5. The method of claim 4, further comprising:
determining the target color map based on one or more predefined target color maps parameterizing the colorings associated with respective one or more further staining laboratory processes.

6. The method of claim 5,
wherein said determining of the target color map depends on a time evolution associated with a transition from the one or more predefined target color maps to the target color map.

7. The method of claim 5,
wherein the one or more predefined target color maps comprise two or more target color maps,
wherein the target color map is determined based on a weighted combination of at least two of the two or more predefined target color maps.

8. The method of claim 1,
wherein the at least one machine-learning logic comprises a neural network comprising a decoder branch and multiple decoder heads for the decoder branch, wherein different ones of the multiple decoder heads are used to obtain different ones of the multiple output images.

9. The method of claim 8,
wherein the different ones of the multiple decoder heads are selected by setting the conditional input.

10. The method of claim 1,
wherein the imaging data of the tissue sample comprises one or more input images depicting at least one of the tissue sample not comprising a chemical stain associated with the virtual stain or comprising a further chemical stain that is not associated with the virtual stain.

11. The method of claim 1,
wherein the imaging data of the tissue sample comprises one or more input images depicting the tissue sample comprising the given virtual stain at a first coloring,
wherein the at least one output image depicting the tissue sample comprises a second coloring different from the first coloring.

12. A method of training at least one machine-learning logic for virtual staining of a tissue sample, the method comprising:
obtaining training imaging data depicting one or more tissue samples,
obtaining multiple reference output images, the multiple reference output images depicting the one or more tissue samples or one or more further tissue samples all comprising a given chemical stain, different reference output images depict the one or more tissue samples or the one or more further tissue samples comprising the given chemical stain at different colorings provided by different staining laboratory processes, and
training the at least one machine-learning logic based on the training imaging data and the multiple reference output images.

13. The method of claim 1,
wherein the machine-learning logic is trained by obtaining training imaging data depicting one or more tissue samples,
obtaining multiple reference output images, the multiple reference output images depicting the one or more tissue samples or one or more further tissue samples all comprising a given chemical stain, different reference output images depict the one or more tissue samples or the one or more further tissue samples comprising the given chemical stain at different colorings provided by different staining laboratory processes, and
training the at least one machine-learning logic based on the training imaging data and the multiple reference output images.

14. A device comprising a processor configured to:
obtain imaging data depicting a tissue sample,
process the imaging data in at least one machine-learning logic, the at least one machine-learning logic being configured to provide multiple output images all depicting the tissue ample comprising a given virtual stain, the multiple output images depicting the tissue sample comprising the given virtual stain at different colorings associated with different staining laboratory processes, and
obtain, from the at least one machine-learning logic, at least one output image of the multiple output images.

15. The device of claim 14,
wherein the at least one machine-learning logic comprises a single machine-learning logic, the single machine-learning logic comprising a conditional input,
wherein setting the conditional input selects between the colorings associated with the different staining laboratory processes, to thereby obtain the respective output image of the multiple output images from the single machine-learning logic.

16. The device of claim 15,
wherein the conditional input selects between the colorings from a predefined set of candidate colorings associated with predefined staining laboratory processes.

17. The device of claim 15,
wherein the conditional input selects between the colorings in accordance with a target color map provided to the conditional input, the target color map parametrizing the coloring associated with a respective staining laboratory process.

18. The device of claim 17, wherein the processor is further configured to:
determine the target color map based on one or more predefined target color maps parameterizing the colorings associated with respective one or more further staining laboratory processes.

19. The device of claim 18,
wherein said determining of the target color map depends on a time evolution associated with a transition from the one or more predefined target color maps to the target color map.

20. The device of claim 18,
wherein the one or more predefined target color maps comprise two or more target color maps,
wherein the target color map is determined based on a weighted combination of at least two of the two or more predefined target color maps.

21. The device of claim 14,
wherein the at least one machine-learning logic comprises a neural network comprising a decoder branch and multiple decoder heads for the decoder branch, -wherein different decoder heads are used to obtain different ones of the multiple output images.

22. The device of claim 21,
wherein the different ones of the multiple decoder heads are selected by setting the conditional input.

23. The device of claim 14,
wherein the imaging data of the tissue sample comprises one or more input images depicting the tissue sample not comprising a chemical stain associated with the virtual stain and/or comprising a further chemical stain that is not associated with the virtual stain.

24. The device of claim 14,
wherein the imaging data of the tissue sample comprises one or more input images depicting the tissue sample comprising the given virtual stain at a first coloring,
wherein the at least one output image depicting the tissue sample comprising a second coloring different from the first coloring.

25. A device comprising a processor configured to:
obtain training imaging data depicting one or more tissue samples,
obtain multiple reference output images, the multiple reference output images depicting the one or more tissue samples or one or more further tissue samples all comprising a given chemical stain, different reference output images depict the one or more tissue samples or the one or more further tissue samples comprising the given chemical stain at different colorings provided by different staining laboratory processes, and
train the at least one machine-learning logic based on the training imaging data and the multiple reference output images.

26. The device of claim 14, wherein the machine-learning logic is trained by a device that comprises a processor configured to:
obtain training imaging data depicting one or more tissue samples,
obtain multiple reference output images, the multiple reference output images depicting the one or more tissue samples or one or more further tissue samples all comprising a given chemical stain, different reference output images depict the one or more tissue samples or the one or more further tissue samples comprising the given chemical stain at different colorings provided by different staining laboratory processes, and
train the at least one machine-learning logic based on the training imaging data and the multiple reference output images.
